(19) United States
(12) Patent Application Publication
(10) Pub. No.: US 2004/0209659 A1
(43) Pub. Date: Oct. 21, 2004

(54) Mobile phone and battery-fixing device

(75) Inventors: Chin-Kai Sun, Banchiao (TW); Shun-Fan Cheng, Kaohsiung (TW)

Correspondence Address: WENG, YI, 68 CANTATA DRIVE, MISSION VIEJO, CA, 92692, US

(73) Assignee: BENQ Corporation

(21) Appl. No.: 10/823,281

(22) Filed: Apr. 13, 2004

(30) Foreign Application Priority Data
Apr. 15, 2003 (TW) 92205877

(51) Int. Cl. H04M 1/00; H04B 1/38

(52) U.S. Cl. 455/575.4; 455/572; 455/575.1

(57) ABSTRACT

A mobile phone and a device for fixing a battery thereof. The mobile phone includes a body and a battery. The body includes a first engaging portion, and the battery includes a second engaging portion. The battery is rotated to a predetermined position and is thereby fixed on the body.

### BACKGROUND OF THE INVENTION

1. Field of the Invention

The invention relates to a mobile phone and a device for fixing a battery; in particular, the invention relates to a mobile phone with a battery that is fixed by rotation.

2. Description of the Related Art

In conventional mobile phones, batteries are fixed within the chassis or structure of the phone, normally within the housing of a phone, or beneath a dedicated cover. Additionally, to remove the battery, some form of release mechanism is normally employed. Disposition of this mechanism is an important design consideration, and can often compromise appearance and efficient function of the phone.

### SUMMARY OF THE INVENTION

In view of this, the invention provides a mobile phone that can fix its battery by rotation.

Accordingly, the invention provides a mobile phone including a body and a battery. The body includes a first engaging portion. The battery includes a second engaging portion. The battery is rotated to a predetermined position and is thereby fixed on the body.

In a preferred embodiment, the first engaging portion is a groove, and the second engaging portion is a protrusion sliding in the groove. The body includes a notch for the protrusion to enter the groove.

In another preferred embodiment, the body includes a first fixed assembly, and the battery includes a first fixed portion corresponding to the first fixed assembly. The battery is positioned on the body by the first fixed assembly and the first fixed portion. The first fixed assembly includes a ball and a first elastic member. The ball is abutted by the first fixed portion in an elastic manner. The first elastic member is connected to the ball, and moves the ball in a predetermined range. It is noted that the first elastic member may be a spring, and the first fixed portion may be a concave portion.

Furthermore, both the first fixed assembly and the first fixed portion may be magnets respectively.

In another preferred embodiment, the body includes a second fixed assembly, and the battery includes a second fixed portion corresponding to the second fixed assembly. The battery is positioned on the body by the second fixed assembly and the second fixed portion. The second fixed assembly includes a stopper and a second elastic member. The stopper is abutted by the second fixed portion in an elastic manner. The second elastic member is connected to the stopper, and moves the stopper in a predetermined range. It is understood that the second elastic member may be a spring; the second fixed portion may be a ratchet.

Furthermore, both the second fixed assembly and the second fixed portion may be magnets respectively. Alternatively, the second fixed assembly may be a cantilever.

In another preferred embodiment, the body includes a battery bay for receiving the battery, and the first fixed assembly and the second fixed assembly are located at opposite corners of the battery bay. The groove is located at a periphery of the battery bay. A periphery of the battery bay is arc-shaped.

In another preferred embodiment, the body is formed with a positioning hole, and the battery includes a shaft corresponding to the positioning hole. The battery rotates relative to the body by inserting the shaft into the positioning hole. Alternatively, the shaft may be disposed on the body, and the positioning hole may be formed on the battery.

In another preferred embodiment, the body includes a first connector, and the battery includes a second connector corresponding to the first connector. The battery is electrically connected to the body by the first connector contacting the second connector.

In this invention, a device for fixing a battery of an electric apparatus is provided. The apparatus includes a body and the battery detachably disposed in the body. The device includes a first engaging portion and a second engaging portion. The first engaging portion is integrally formed on the body, and the second engaging portion is integrally formed on the battery. The battery is rotated to a predetermined position and is thereby fixed on the body.

### BRIEF DESCRIPTION OF THE DRAWINGS

The present invention can be more fully understood by reading the subsequent detailed description and examples with references made to the accompanying drawings, wherein:

FIG. 1a is an exploded view of a mobile phone as disclosed in a first embodiment of this invention;

FIG. 1b is a perspective view of the assembled mobile phone in FIG. 1a;

FIGS. 2a-2b are perspective views of a body of the mobile phone in FIG. 1a;

FIG. 2c is a schematic view showing a cross section of a first fixed assembly in FIG. 2a;

FIG. 2d is a schematic view showing a cross section of a second fixed assembly in FIG. 2b;

FIGS. 3a-3b are perspective views of a battery of the mobile phone in FIG. 1a;

FIG. 4 is a perspective view of the mobile phone in FIG. 1a during assembly;

FIG. 5 is an exploded view of a mobile phone as disclosed in a second embodiment of this invention;

FIG. 6 is an exploded view of a mobile phone as disclosed in a third embodiment of this invention; and

FIGS. 7a-7b are exploded views of a mobile phone as disclosed in a fourth embodiment of this invention.

### DETAILED DESCRIPTION OF THE INVENTION

### FIRST EMBODIMENT

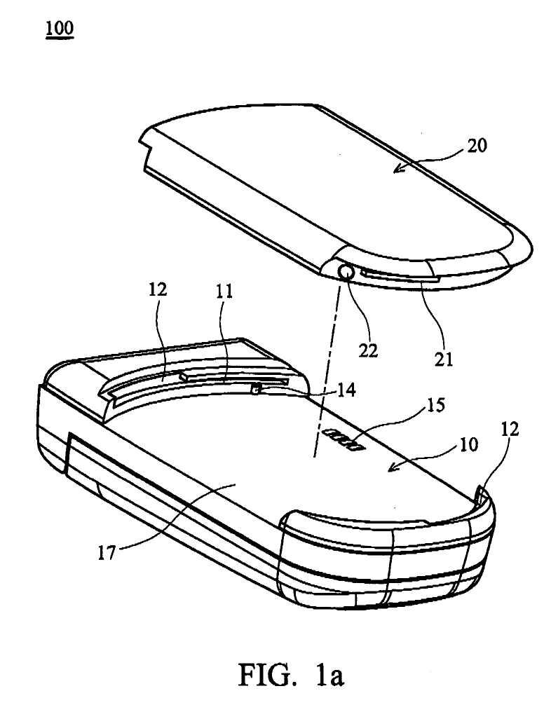

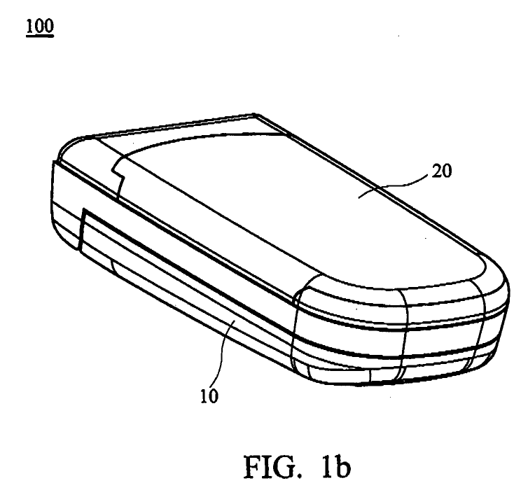

FIGS. 1a-1b are schematic views of a mobile phone 100 as disclosed in a first embodiment of this invention. In this embodiment, the mobile phone 100 includes a body 10 and a battery 20.

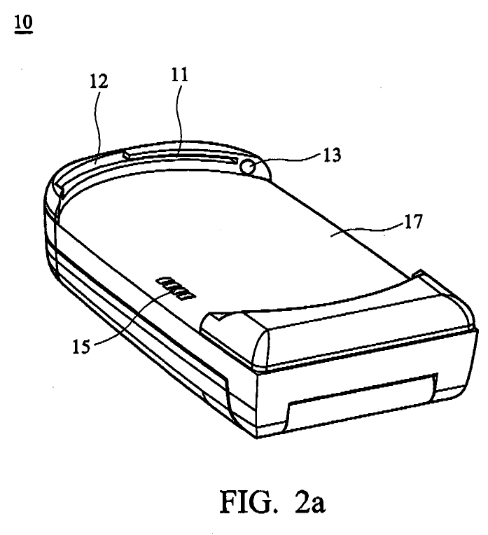

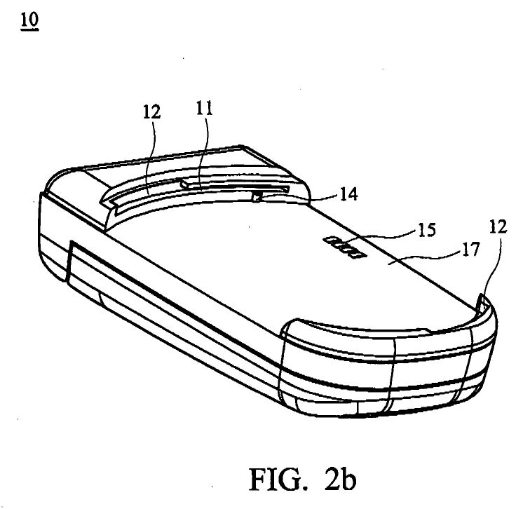

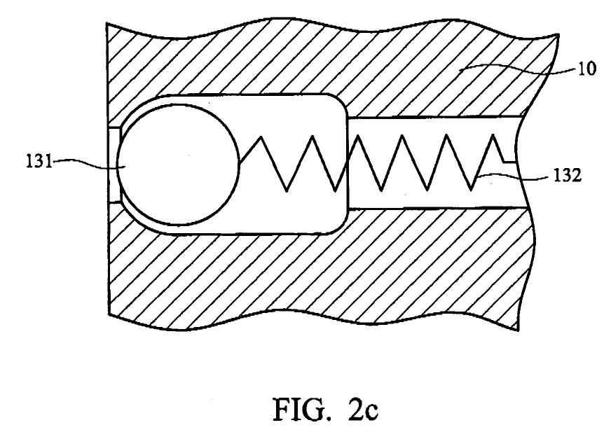

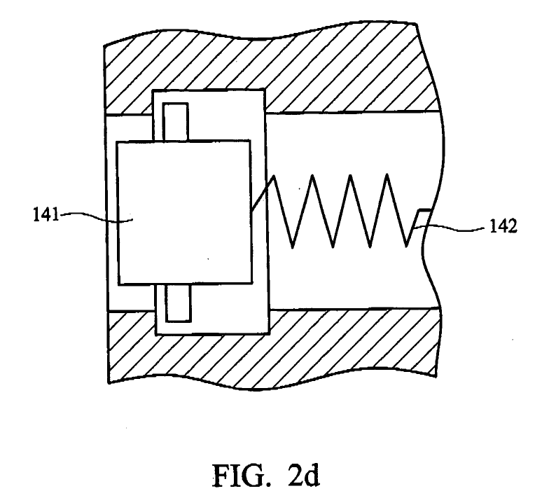

Referring FIGS. 2a-2b, the body 10 is a basic component of the mobile phone 100, and includes two first engaging portions 11, two notches 12, a first fixed assembly 13, a second fixed assembly 14, a first connector 15, and a battery bay 17. Other basic components of the mobile phone 100 are also disposed in or on the body 10, and are not illustrated in the figures since they are less related to this invention, and their detailed description is omitted herein.

The battery bay 17 is integrally formed in the central portion of the body 10, and the battery 20 is received therein. Preferably, a periphery of the battery bay 17 is arc-shaped as shown in FIGS. 2a-2b. The first engaging portions 11 are formed at the periphery of the battery bay 17 respectively. As shown in FIGS. 2a-2b, each of the first engaging portions 11 is a groove. Each of the notches 12 communicates with the first engaging portion 11. The first connector 15 is disposed on the battery bay 17, and preferably includes a plurality of elastic members.

With reference to FIGS. 2a and 2c, the first fixed assembly 13 formed at the periphery of the battery bay 17, includes a ball 131 and a first elastic member 132. The ball 131 is moveably disposed in the body 10 by the first elastic member 132. The first elastic member 132 is connected to the ball 131, and moves the ball 131 in a predetermined range. It is noted that the first elastic member 132 may be a spring.

Referring to FIG. 2b and FIG. 2d, the second fixed assembly 14 is formed at the periphery of the battery bay 17, and is located opposite to the first fixed assembly 13. The second fixed assembly 14 includes a stopper 141 and a second elastic member 142. The stopper 141 is moveably disposed in the body 10 by the second elastic member 142. The second elastic member 142 is connected to the stopper 141, and moves the stopper 141 in a predetermined range. It is understood that the second elastic member 142 may be a spring.

It is noted that the first fixed assembly 13 and the second fixed assembly 14 are preferably located at opposite corners of the battery bay 17.

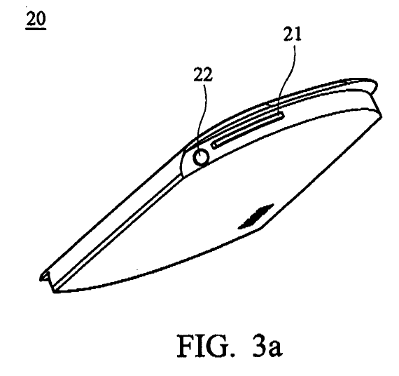

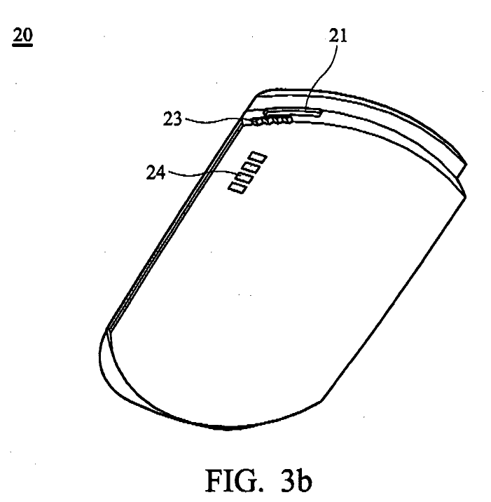

Referring to FIGS. 1a-1b, the battery 20 is detachably disposed in the body 10, and provides power to the mobile phone 100. As shown in FIGS. 3a-3b, the battery 20 includes two second engaging portions 21, a first fixed portion 22, a second fixed portion 23, and a second connector 24.

Referring to FIGS. 3a-3b, the second engaging portions 21 are formed at each end of the battery 20. Each second engaging portion 21 may be disposed by sliding via the notch 12 into the first engaging portion 11. It is noted that in this embodiment, the first engaging portion 11 is a groove and the second engaging portion 21 is a protrusion. However, they are not limited to this. For example, the first engaging portion may be a protrusion, and the second engaging portion may be a groove.

As shown in FIG. 3a, the first fixed portion 22 may be a round concave portion, abutted by the ball 131 of the first fixed assembly 13 in an elastic manner. Thus, the battery 20 can be stably positioned in the body 10. As shown in FIG. 3b, the second fixed portion 23 may be a ratchet, to interfere with the stopper 141 of the second fixed assembly 14. The interference provides acknowledgement that the battery 20 is fixed.

The second connector 24 includes a plurality of contacts, and corresponds to the first connector 15 of the body 10. The battery 20 is electrically connected to the body 10 by the first connector 15 contacting the second connector 24.

The structure of the mobile phone 100 of this embodiment is described above, and the manner of assembly is described in the following.

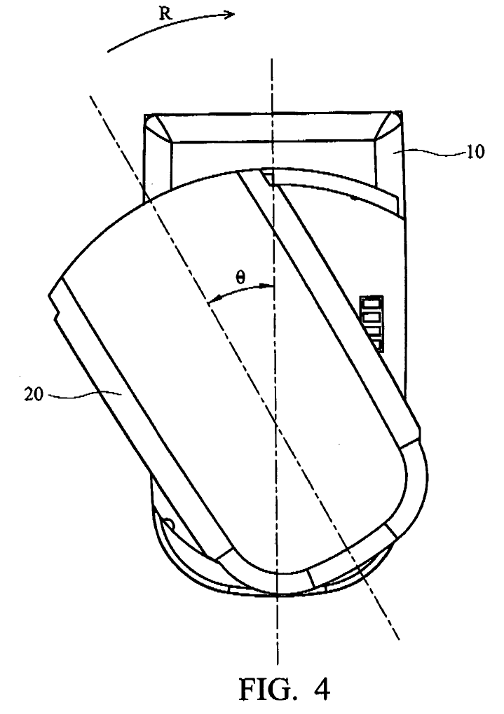

As shown in FIG. 4, the battery 20 is disposed downward on the body 10 at a predetermined angle θ. The second engaging portions 21 of the battery 20 are disposed in the first engaging portions 11 of the body 10 via the notches 12. Then, by rotating the battery 20 in the direction indicated by arrow R, the battery 20 can be rotated to a predetermined position by the first engaging portions 11 and the second engaging portions 21. Before the battery 20 is rotated to the predetermined position, noise is caused when the stopper 141 of the body 10 interferes with the second fixed portion 23 of the battery 20, indicating that the battery 20 is being fixed. To fix the battery 20 completely in the body 10, the first fixed portion 22 of the battery 20 is forced to receive the ball 131 of the body 10 therein.

The battery 20 can be removed from the body 10 by reversing the steps.

Since the battery is disposed in the body by rotation in the mobile phone of this embodiment, the appearance of the mobile phone is maintained.

It is understood that the battery-fixing device of this embodiment is applied to a mobile phone, but is not limited to this, and can be applied in other electronic apparatuses requiring batteries.

### SECOND EMBODIMENT

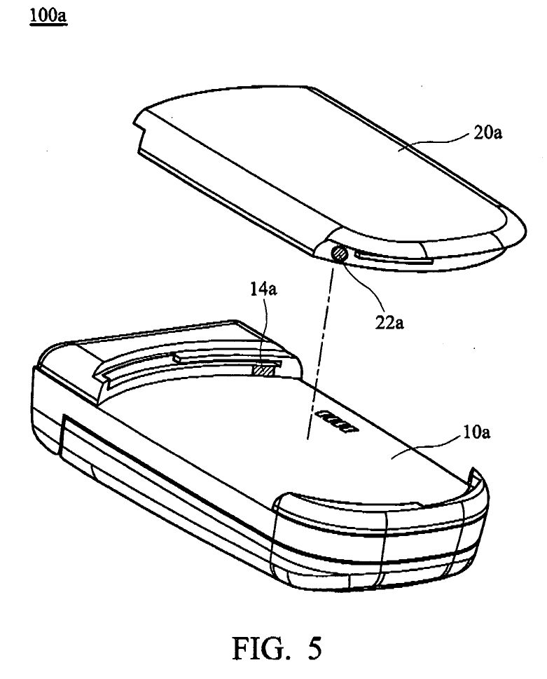

FIG. 5 Is a schematic view of a mobile phone 100a as disclosed in a second embodiment of this invention. In this embodiment, the mobile phone 100a includes a body 10a and a battery 20a. The components of this embodiment same as those of the first embodiment are given the similar labels, and their description is omitted.

The second embodiment differs from the first embodiment in that the first fixed assembly (not labeled), the first fixed portion 22a, the second fixed assembly 14a, and the second fixed portion (not labeled) may be magnets respectively in this embodiment.

It is understood that in a variant embodiment, the first fixed assembly and the first fixed portion are magnets while the second fixed assembly and the second fixed portion are the same as those in the first embodiment. Alternatively, in another variant embodiment, the second fixed assembly and the second fixed portion are magnets while the first fixed assembly and the first fixed portion are the same as those in the first embodiment.

### THIRD EMBODIMENT

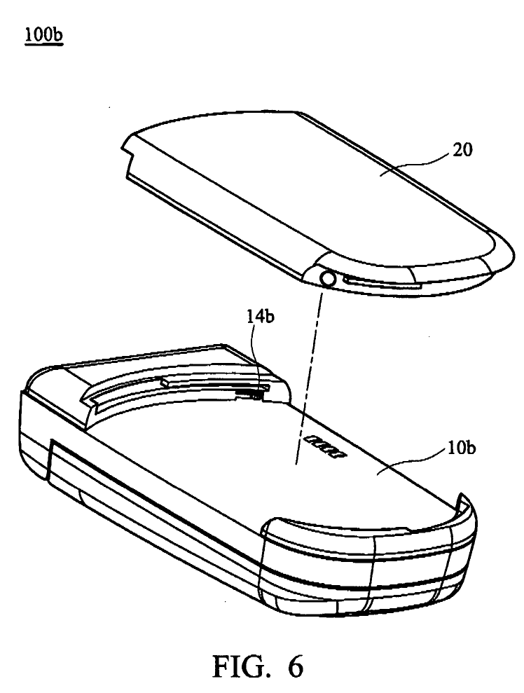

FIG. 6 is a schematic view of a mobile phone 100b as disclosed in a third embodiment of this invention. In this embodiment, the mobile phone 100b includes a body 10b and a battery 20. The components of this embodiment same as those of the first embodiment are given the similar labels, and their description is omitted.

The third embodiment differs from the first embodiment in that the second fixed assembly 14b is a cantilever.

### FOURTH EMBODIMENT

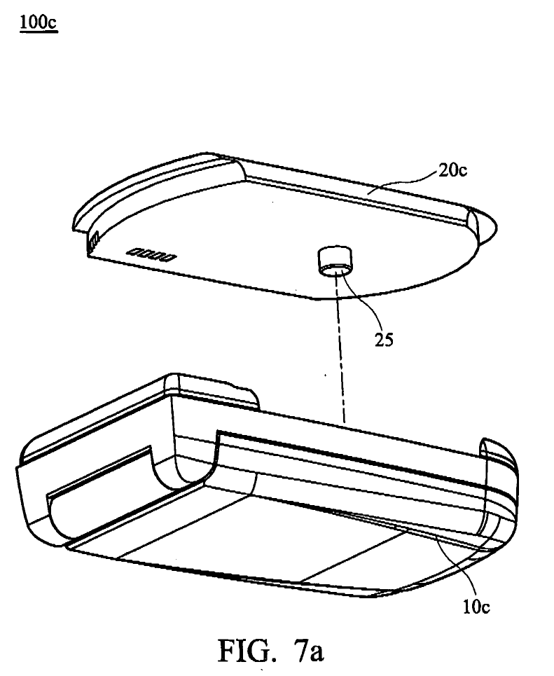

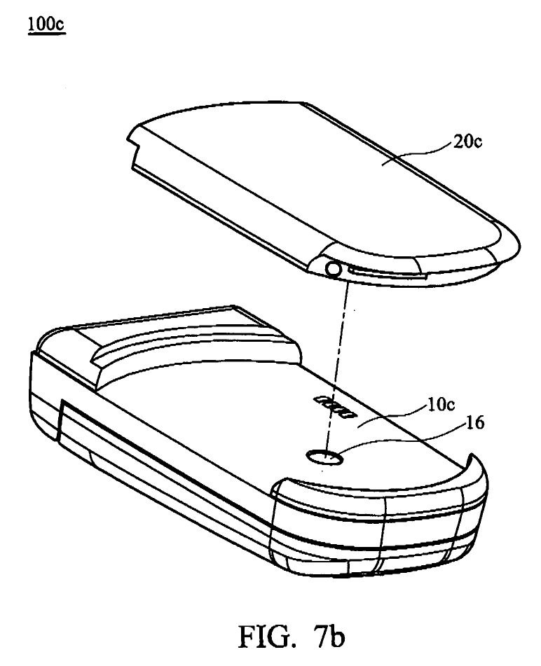

FIGS. 7a-7b are schematic views of a mobile phone 100c as disclosed in a fourth embodiment of this invention. In this embodiment, the mobile phone 100c includes a body 10c and a battery 20c. The components of this embodiment same as those of the first embodiment are given the similar labels, and their description is omitted.

The fourth embodiment differs from the first embodiment in that the body 10c is formed with a positioning hole 16 and the battery 20c includes a shaft 25 corresponding to the positioning hole 16. The battery 20c can rotate relative to the body 10c by inserting the shaft 25 into the positioning hole 16.

It is noted that the positions of the positioning hole and the shaft can be reversed. That is, the shaft may be disposed on the body, and the positioning hole may be formed on the battery.

While the invention has been described by way of example and in terms of the preferred embodiments, it is to be understood that the invention is not limited to the disclosed embodiments. To the contrary, it is intended to flipper various modifications and similar arrangements (as would be apparent to those skilled in the art). Therefore, the scope of the appended claims should be accorded the broadest interpretation so as to encompass all such modifications and similar arrangements.

What is claimed is:

1. A mobile phone comprising:
a body including a first engaging portion; and
a battery including a second engaging portion, wherein the battery is rotated to a predetermined position by means of the first engaging portion and the second engaging portion and is thereby fixed on the body.

2. The mobile phone as claimed in claim 1, wherein the first engaging portion is a groove, and the second engaging portion is a protrusion sliding in the groove.

3. The mobile phone as claimed in claim 2, wherein the body further includes a notch for inserting the protrusion into the groove.

4. The mobile phone as claimed in claim 1, wherein the body further includes a first fixed assembly, the battery further includes a first fixed portion corresponding to the first fixed assembly, and the battery is positioned on the body by the first fixed assembly and the first fixed portion.

5. The mobile phone as claimed in claim 4, wherein the first fixed assembly comprises:
a ball abutted by the first fixed portion in an elastic manner; and
a first elastic member, connected to the ball, for moving the ball in a predetermined range.

6. The mobile phone as claimed in claim 4, wherein both the first fixed assembly and the first fixed portion are magnets respectively.

7. The mobile phone as claimed in claim 4, wherein the body further includes a second fixed assembly, the battery further includes a second fixed portion corresponding to the second fixed assembly, and the battery is positioned on the body by the second fixed assembly and the second fixed portion.

8. The mobile phone as claimed in claim 7, wherein the second fixed assembly comprises:
a stopper abutted by the second fixed portion in an elastic manner; and
a second elastic member, connected to the stopper, for moving the stopper in a predetermined range.

9. The mobile phone as claimed in claim 8, wherein the second fixed portion is a ratchet.

10. The mobile phone as claimed in claim 7, wherein the second fixed assembly is a cantilever.

11. The mobile phone as claimed in claim 7, wherein the body further includes a battery bay for receiving the battery, and the first fixed assembly and the second fixed assembly are located at opposite corners of the battery bay.

12. The mobile phone as claimed in claim 1, wherein the body is formed with a positioning hole, the battery includes a shaft corresponding to the positioning hole, and the battery rotates relative to the body by inserting the shaft into the positioning hole.

13. The mobile phone as claimed in claim 1, wherein the body is formed with a shaft, the battery includes a positioning hole corresponding to the shaft, and the battery rotates relative to the body by inserting the shaft into the positioning hole.

14. The mobile phone as claimed in claim 1, wherein the body includes a first connector, the battery includes a second connector corresponding to the first connector, and the battery is electrically connected to the body by the first connector contacting the second connector.

15. A device for fixing a battery of an electric apparatus, wherein the electric apparatus includes a body and the battery detachably disposed in the body, and the device comprises:
a first engaging portion integrally formed on the body; and
a second engaging portion integrally formed on the battery, wherein the battery is rotated to a predetermined position by means of the first engaging portion and the second engaging portion and is thereby fixed on the body.

16. The device as claimed in claim 15, wherein the first engaging portion is a groove, and the second engaging portion is a protrusion sliding in the groove.

17. The device as claimed in claim 16, wherein the body further includes a notch for the protrusion entering into the groove.

18. The device as claimed in claim 15, further comprising:
a first fixed assembly disposed on the body; and
a first fixed portion, corresponding to the first fixed assembly, disposed on the battery, wherein the battery is positioned on the body by the first fixed assembly and the first fixed portion.

19. The device as claimed in claim 18, wherein the first fixed assembly comprises:
a ball abutted by the first fixed portion in an elastic manner; and
a first elastic member, connected to the ball, for moving the ball in a predetermined range.

20. The device as claimed in claim 18, wherein both the first fixed assembly and the first fixed portion are magnets respectively.

21. The device as claimed in claim 18, further including:
a second fixed assembly disposed on the body; and
a second fixed portion, corresponding to the second fixed assembly, disposed on the battery, wherein the battery is positioned on the body by the second fixed assembly and the second fixed portion.

22. The device as claimed in claim 21, wherein the second fixed assembly comprises:
a stopper abutted by the second fixed portion in an elastic manner; and
a second elastic member, connected to the stopper, for moving the stopper in a predetermined range.

23. The device as claimed in claim 21, wherein the body further includes a battery bay for receiving the battery, and the first fixed assembly and the second fixed assembly are located at opposite corners of the battery bay.

24. The device as claimed in claim 15, further comprising:
a positioning hole integrally formed on the body; and
a shaft, corresponding to the positioning hole, integrally formed on the battery, wherein the battery rotates relative to the body by inserting the shaft into the positioning hole.

25. The device as claimed in claim 15, further comprising:
a shaft integrally formed on the body; and
a positioning hole, corresponding to the shaft, integrally formed on the battery, wherein the battery rotates relative to the body by inserting the shaft into the positioning hole.
